(19) United States
(12) Patent Application Publication
(10) Pub. No.: US 2026/0287238 A1
(43) Pub. Date: Sep. 24, 2026

(54) CAN TOSSING COOLER

(71) Applicant: BeerMe LLC, Dover, DE (US)

(72) Inventor: Anthony Barrett Sinclair, Los Gatos, CA (US)

(21) Appl. No.: 19/574,753

(22) Filed: Mar. 23, 2026

Related U.S. Application Data
(60) Provisional application No. 63/776,597, filed on Mar. 24, 2025.

(51) Int. Cl. F25D 3/08; F25D 23/02; F25D 25/00

(52) U.S. Cl. CPC F25D 3/08; F25D 23/025; F25D 23/028; F25D 25/00; F25D 2300/00; F25D 2303/08222; F25D 2303/0843; F25D 2331/805; F25D 2700/00

(57) ABSTRACT

A beverage dispensing apparatus includes a container for storing beverage containers, a launch assembly with a launch arm pivotable about a fulcrum having a beverage container receiving end and a drive end, a single-motor-driven cam with variable radius, constant radius, and drop-off regions, the launch arm engaging the cam, and a biasing member coupled to the drive end. Rotation through the variable radius region tensions the biasing member to store energy. The constant radius region maintains tension without continuous motor power. Further rotation of the cam to the drop-off region releases stored energy to pull the drive end, pivoting the launch arm to propel the beverage container.

### CROSS-REFERENCE TO RELATED APPLICATIONS

This application claims priority to and the benefit of U.S. Provisional Application No. 63/776,597, filed Mar. 24, 2025, which is hereby incorporated by reference in its entirety.

### FIELD OF INVENTION

The present disclosure relates to beverage dispensing apparatus, and more particularly to a beverage dispensing cooler that utilizes a single-motor, cam-based launching mechanism to propel beverage containers upward upon user activation.

### BACKGROUND

Portable coolers are commonly used in social and outdoor settings to store and maintain beverage containers at desired temperatures. These coolers typically include insulated bodies configured to retain cold temperatures for extended periods, allowing users to enjoy chilled beverages during gatherings, tailgating events, camping trips, and other recreational activities. While conventional coolers effectively preserve beverage temperature, users must manually retrieve individual beverage containers from the cooler interior, which may require opening a lid, reaching into the cooler, and locating a desired beverage among stored items. This manual retrieval process can be tedious and inconvenient.

Accordingly, there remains room for improvement in beverage dispensing apparatus that can provide reliable, energy-efficient launching of beverage containers while reducing mechanical complexity.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a beverage dispensing apparatus is provided. The apparatus includes a container configured to store a plurality of beverage containers. The apparatus includes a launch assembly including a launch arm pivotable about a fulcrum and having a beverage container receiving end and a drive end. The apparatus includes a cam driven by a single motor and having a cam profile with a variable radius region, a constant radius region, and drop-off region, wherein the launch arm engages the cam to move the launch arm. The apparatus includes a biasing member coupled to the drive end of the launch arm. Rotation of the cam through the variable radius region tensions the biasing member to store energy. The constant radius region maintains the biasing member in a stable tensioned state without continuous motor power. Further rotation of the cam to the drop-off region of the cam profile releases stored energy from the biasing member to pull the drive end of the launch arm, thereby pivoting the launch arm about the fulcrum to propel the beverage container from the beverage container receiving end of the launch arm.

According to other aspects of the present disclosure, the beverage dispensing apparatus may include one or more of the following features. The drop-off region may be positioned between the constant radius region and the variable radius region, the drop-off defining a reduced radius portion that has a radius less than the constant radius region. The drop-off region may define a launch region that causes rapid displacement of the launch arm. The biasing member may include a spring having a first end coupled to the launch arm and a second end coupled to a fixed attachment location on the launch assembly. The apparatus may further include a load assembly configured to feed beverage containers to a beverage container receiving end of the launch arm. The load assembly may include a loading element pivotable about a fulcrum and having a first end configured to receive a beverage container and a second end, and a ramp configured to guide beverage containers toward the first end of the loading element. The first end of the loading element may include a seat configured to receive the beverage container and an upstanding wall configured to retain the beverage container during transfer to the beverage container receiving end of the launch arm. The apparatus may further include a beverage container stop door positioned between the load assembly and the launch assembly, the beverage container stop door configured to control release of beverage containers onto the beverage container receiving end of the launch arm. The container may include an insulated body and a lid, the lid defining an aperture through which the beverage container is propelled. The aperture may be covered by at least one openable panel. The apparatus may further include a cam position sensor configured to detect a rotational position of the cam. The constant radius region may define a substantially circular arc concentric with a cam axis such that force from the biasing member acts substantially radially on the cam, producing no net torque tending to rotate the cam, thereby rendering the cam non-backdrivable in the tensioned state. The constant radius region may maintain the biasing member in a stable tensioned state without a separate latching mechanism.

According to another aspect of the present disclosure, a method of dispensing a beverage container is provided. The method includes loading a beverage container into a cradle of a launch arm. The method includes rotating a cam with a single motor to move a portion of the launch arm through a variable radius region of the cam, thereby tensioning a biasing member coupled to the launch arm. The method includes holding the biasing member in a tensioned state by positioning the portion of the launch arm in a constant radius region of the cam without continuous motor power. The method includes releasing stored energy from the biasing member by rotating the cam to move the portion of the launch arm through a reduced radius region of the cam, thereby pivoting the launch arm to propel the beverage container.

According to other aspects of the present disclosure, the method may include one or more of the following features. The method may further include detecting a presence of the beverage container in the cradle with a beverage container sensor prior to rotating the cam. Loading the beverage container into the cradle may include receiving the beverage container on a first end of a loading element and pivoting the loading element about a fulcrum to transfer the beverage container from the first end of the loading element to the cradle. Optionally, the method may further include detecting a presence of the beverage container in the loading element with, for example a beverage container sensor, prior to rotating the cam. The method may further include storing a plurality of beverage containers on a ramp adjacent the loading element, and transferring the beverage container from the ramp to the first end of the loading element prior to transferring the beverage container to the cradle. The method may further include propelling the beverage container through an aperture defined in a lid of an insulated container.

According to another aspect of the present disclosure, a beverage dispensing apparatus is provided. The apparatus includes an insulated container having a body and a lid with an aperture. The apparatus includes a load assembly configured to store and feed beverage containers toward a launch position. The apparatus includes a launch assembly disposed within the insulated container and including a launch arm pivotable to propel a beverage container through the aperture. The apparatus includes a single motor. The apparatus includes a cam coupled to the single motor and engaging the launch arm. The apparatus includes a biasing member configured to store energy when the cam rotates to a first position and release energy when the cam rotates to a second position to pivot the launch arm.

According to other aspects of the present disclosure, the beverage dispensing apparatus may include one or more of the following features. The cam may include a variable radius region, a constant radius region, and a launch region, wherein the constant radius region maintains the biasing member in a tensioned state at the first position without continuous motor power. The launch region may define a drop-off between the constant radius region and the variable radius region, the drop-off causing rapid release of stored energy from the biasing member when the cam rotates to the second position. The launch arm may include a cam follower engaging the cam and a cradle configured to receive and hold a beverage container during a launch sequence.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a front perspective view of an insulated container in a closed configuration, according to the present disclosure.

FIG. 2 is a front perspective view of the insulated container of FIG. 1 with a beverage container launched from the insulated container.

FIG. 3 is a top perspective view of the insulated container of FIG. 1 with a lid in an open position.

FIG. 4 is a perspective view of internal components of the insulated container of FIG. 1.

FIG. 5 is a rear plan view of the internal components of FIG. 4.

FIG. 6 is a side perspective view of a load assembly of the insulated container of FIG. 1, with elements of the assemblies removed to show the internal components.

FIG. 7 is a side elevation view of the load assembly and a launch assembly of FIG. 6.

FIG. 8 is a perspective view of a loading element, according to one embodiment of the present disclosure.

FIG. 9A is a perspective view of a launch arm, according to one embodiment of the present disclosure.

FIG. 9B is a side elevation view of the launch arm of FIG. 9A.

FIG. 10 is a side perspective view of the launch assembly with a motor and cam exposed, according to one embodiment of the present disclosure.

FIG. 11 is a side elevation view of the launch assembly of FIG. 10 with the cam exposed.

FIG. 12 is a front plan view of a cam showing a cam profile, according to one embodiment of the present disclosure.

FIGS. 13 and 14 illustrate the launch assembly and load assembly prior to loading of a beverage container into the launch arm.

FIG. 15 is a front elevation view of the load assembly and launch assembly with beverage containers loaded, with elements of the assemblies removed to show the internal components.

FIGS. 16 and 17 illustrate the launch assembly and load assembly in a first stage of loading.

FIG. 18 is a perspective view of the launch assembly showing a relationship between a launch arm and a beverage container stop door.

FIGS. 19 and 20 illustrate the launch assembly and load assembly in a second stage of loading.

FIGS. 21 and 22 illustrate the launch assembly and load assembly in a loaded configuration.

FIGS. 23 and 24 illustrate the launch assembly and load assembly in a first stage of launching.

FIGS. 25 and 26 illustrate the launch assembly and load assembly in a second stage of launching.

FIG. 27 is a front cross-sectional elevation view of the insulated container of FIG. 1.

FIGS. 28 and 29 illustrate alternative features of a beverage dispensing apparatus, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a beverage dispensing apparatus, such as a portable cooler, configured to store a plurality of beverage containers and to launch individual beverage containers upon user activation. For example, the present disclosure relates to a cooler that stores soda or beer cans and launches or tosses them from inside the cooler to outside of the cooler for the user to catch. The apparatus employs a cam-based launching mechanism driven by a single motor to both store mechanical energy and release that energy to propel a beverage container upward from the apparatus. The cam-based launching mechanism may also drive the loading of the beverage containers from the load assembly to the launch assembly.

In some embodiments, the apparatus includes a load assembly configured to organize and feed beverage containers toward a launch position, and a launch assembly configured to receive a beverage container and propel the beverage container through an opening in the apparatus. The launch assembly may include a launch arm that pivots about a fulcrum to impart launching force to the beverage container.

The cam-based mechanism may include a cam having a cam profile with regions of varying radius. A biasing member, such as a spring, may be coupled to the launch arm. Rotation of the cam through a variable radius region of the cam profile moves the launch arm and tensions the biasing member to store energy. The cam profile may further include a constant radius region that maintains the biasing member in a tensioned state without continuous motor power. The cam profile includes a drop-off region of reduced radius that, when traversed by a portion of the launch arm, releases the stored energy from the biasing member to pivot the launch arm about the fulcrum/pivot point and propel the beverage container. The controlled release of stored energy ensures a repeatable launch height and trajectory.

The single motor configuration reduces mechanical complexity compared to systems that employ multiple motors or separate loading and launching mechanisms. The cam geometry may provide a non-backdrivable characteristic such that, when the cam is rotated to a loaded position, force from the biasing member acts substantially radially on the cam, thereby holding the biasing member in the tensioned state, which may be a stable tensioned state, without requiring continuous motor power or a separate latching mechanism. This configuration may extend battery life, reduce potential failure points, reduce the amount of heat generated by the motor.

In some embodiments, the apparatus includes a container, such as an insulated cooler body, configured to maintain beverage containers at a desired temperature. The container may include a lid with an aperture through which the beverage container is propelled during a launch sequence. In some alternatives, the aperture may be covered by one or more openable panels.

The apparatus may further include various sensors, activation elements, and control components. In some embodiments, a user-operated activation element, such as a kick plate or button, initiates the launch sequence. In some alternatives, the apparatus includes sensors configured to detect the presence of a beverage container in the launch or “ready to load” position, to detect the rotational position of the cam, or to detect obstructions in a launch path above the apparatus. A controller may be provided to coordinate operation of the motor, sensors, and activation elements. A power supply, such as a battery pack, may be disposed within the apparatus to provide electrical power to the motor, controller, sensors, and activation elements.

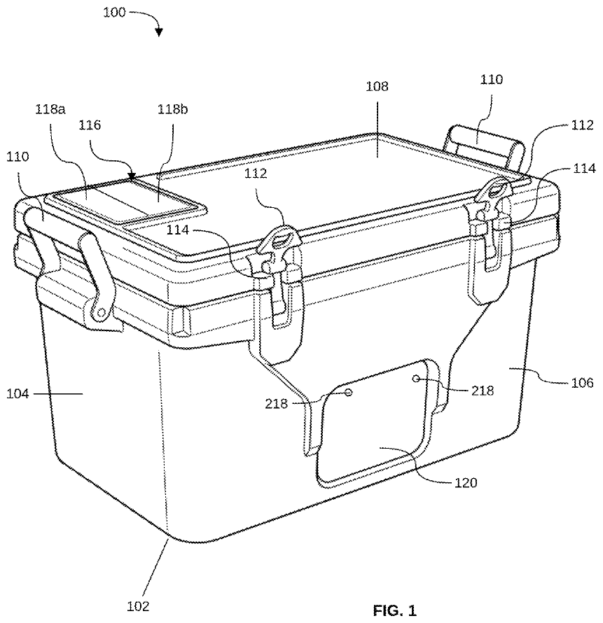

Referring to FIG. 1, an insulated container 100, such as a portable cooler, is shown in a closed configuration. Insulated container 100 serves as a beverage dispensing apparatus configured to store a plurality of beverage containers. Insulated container 100 includes a body 102 having sidewalls 104 and a front wall 106. Body 102 may be formed of insulated material to maintain beverage containers at a desired temperature.

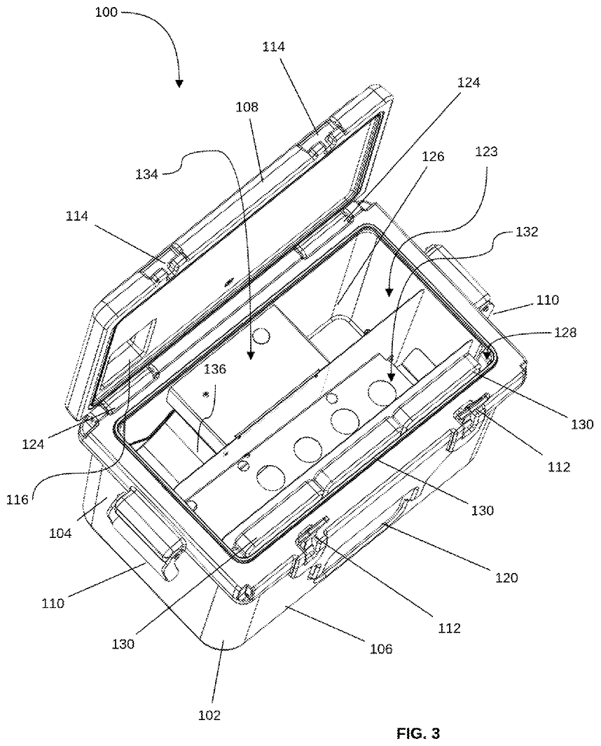

A lid 108 is positioned on top of body 102. In some embodiments, lid 108 is attached to body 102 by hinges 124 positioned along a rear edge of body 102 (as shown in FIG. 3), permitting lid 108 to pivot between open and closed positions. In other embodiments, lid 108 may be completely detachable from body 102. In the illustrated embodiment, latches 112 extend from body 102 and engage corresponding catches 114 on lid 108 to hold lid 108 in the closed configuration. This latch and catch arrangement permits lid 108 to be selectively opened for access to the interior of insulated container 100 and closed to maintain thermal insulation. In other alternative, the lid 108 may be held closed in any suitable manner. Handles 110 are attached to body 102 on opposing sides of insulated container 100. Handles 110 facilitate portability of insulated container 100.

Lid 108 defines an aperture 116 in an upper surface thereof. Aperture 116 extends through lid 108 and permits launching of beverage containers from within insulated container 100. Aperture 116 is covered by at least one openable panel. In the illustrated embodiment, aperture 116 is covered by a first panel 118a and a second panel 118b. First panel 118a and second panel 118b are biased toward a closed position and are openable to permit a beverage container to be propelled through aperture 116 during a launch sequence. The panels may be biased toward the closed position by springs, torsion bars, elastic members, magnetic elements, or gravity acting on weighted portions of the panels. In some embodiments, first panel 118a and second panel 118b may be hinged or otherwise movably coupled to lid 108 such that the panels open in response to a beverage container being launched and return to a closed position after the beverage container passes through aperture 116.

In some alternatives, a launch activation element 120 is mounted on front wall 106 of body 102. Launch activation element 120 may be a user-operated trigger mechanism configured to initiate the launch sequence. In other embodiments, launch activation element 120 may be positioned on sidewalls 104, on lid 108, or on a top surface of body 102. Launch activation element 120 may take various forms including, but not limited to, a push button, a toggle switch, a touch-sensitive pad, a proximity sensor, or a kick plate configured for foot actuation. In some embodiments, launch activation element 120 is a kick-button located on the exterior of body 102, permitting a user to activate the launch sequence by foot actuation while the user's hands remain free to catch the launched beverage container. In other embodiments, the apparatus may include a wireless activation system, such as a Bluetooth-enabled remote control, a smartphone application, a voice-activated controller, or a radio frequency (RF) remote, configured to wirelessly communicate with controller 166 to initiate the launch sequence. In still other embodiments, the apparatus may include multiple activation elements positioned at different locations on insulated container 100 to provide user flexibility in initiating the launch sequence.

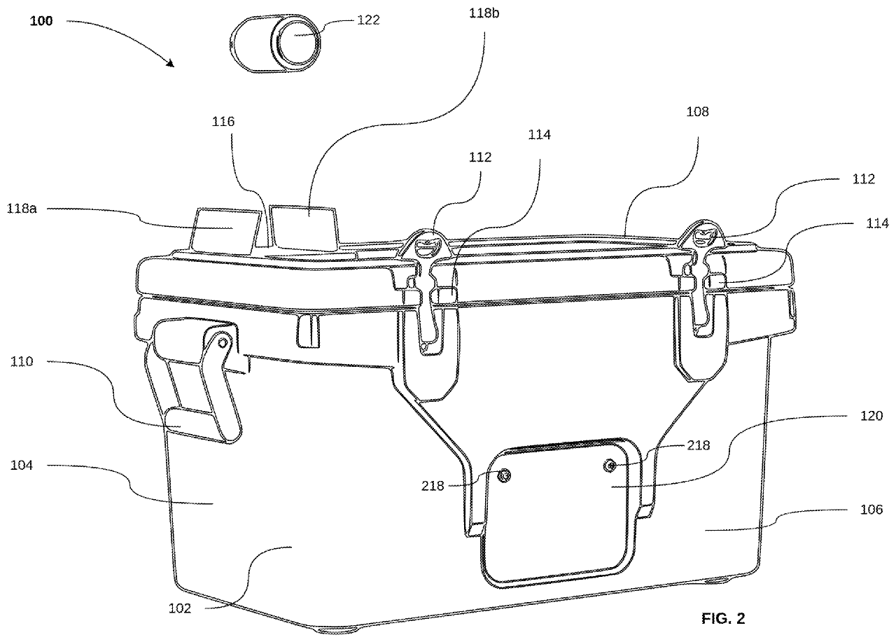

Referring to FIG. 2, insulated container 100 is shown during a launching operation with a beverage can 122 in mid-air above the cooler. FIG. 2 depicts the launching functionality of insulated container 100, illustrating how a beverage container is propelled through aperture 116 defined in lid 108. The panels may return to a closed position after can 122 passes through aperture 116.

Referring to FIG. 3, insulated container 100 is shown with lid 108 in an open position, revealing the interior arrangement of components. Lid 108 is attached to body 102 by hinges 124 positioned along a rear edge of body 102. Hinges 124 permit lid 108 to pivot between the open and closed positions shown in FIGS. 1-3. When lid 108 is in the open position, the interior of insulated container 100 is accessible for loading beverage containers, servicing internal components, or adding ice packs 130.

The interior of body 102 defines a compartment 123 that may be divided into functional regions. An optional storage subcompartment 126 is disposed within compartment 123 and is configured to hold items, such as a plurality of beverage containers, food stuffs, utensils, or other items. A cooling subcompartment 128 is also disposed within compartment 123 and is bounded by a load assembly 132 and an inner surface of body 102. In the illustrated embodiment, ice packs 130, such as reusable ice packs, are positioned within cooling subcompartment 128 to maintain beverage containers at a desired temperature. In some embodiments, ice packs 130 may be removable and replaceable to permit recharging or substitution. In some alternatives, cooling subcompartment 128 may receive loose ice, gel packs, or other cooling media in addition to or instead of ice packs 130.

With continued reference to FIG. 3, load assembly 132 is positioned within compartment 123 and is configured to store and feed beverage containers toward a launch position. Load assembly 132 organizes beverage containers and directs the beverage containers sequentially toward a launch assembly 134 for dispensing. Load assembly 132 may include ramps, guides, or other structures that store the beverage containers and permit them to advance toward the launch position under the influence of gravity and/or mechanical actuation.

A launch assembly 134 is disposed within insulated container 100 and is configured to receive a beverage container from load assembly 132 and propel the beverage container through aperture 116 of lid 108. Launch assembly 134 includes a launch arm 136 that is pivotable to impart launching force to a beverage container. Launch arm 136 is aligned with aperture 116 when lid 108 is in the closed position, such that a beverage container propelled by launch arm 136 travels upward through aperture 116 and exits insulated container 100. As described previously, first panel 118a and second panel 118b covering aperture 116 may open in response to the beverage container being launched and return to a closed position after the beverage container passes through aperture 116.

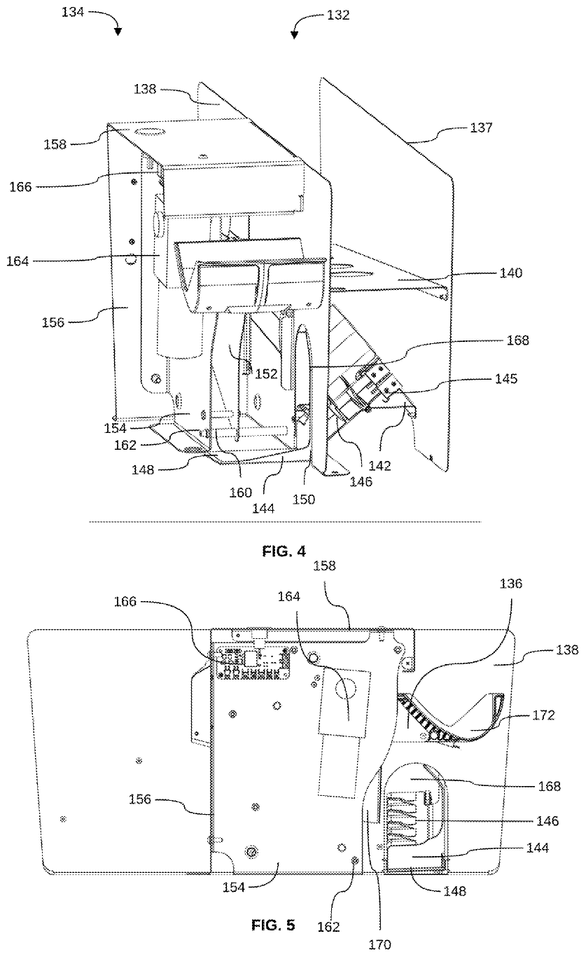

Referring to FIGS. 4 and 5, the internal components of insulated container 100 are shown with the outer body removed, revealing the structural arrangement of load assembly 132 and launch assembly 134. Load assembly 132 and launch assembly 134 are supported by a structural framework that positions the components within compartment 123 of insulated container 100.

Load assembly 132 includes a load assembly front vertical support 137 and a load assembly rear vertical support 138 that provide structural framing for load assembly 132. Load assembly front vertical support 137 and load assembly rear vertical support 138 are oriented vertically and are spaced apart to define a region within which beverage containers are stored and directed toward launch assembly 134. In some embodiments, load assembly front vertical support 137 and load assembly rear vertical support 138 may be formed of rigid material such as plastic, metal, or composite material. In the illustrated embodiment, the load assembly and launch assembly supports are shown as panels or plates. However, in some alternatives, the supports could be framing instead of panels, such as metal or plastic framing. In one embodiment, the supports may be framing formed from wire supports.

An upper ramp 140 is mounted at an upper region of load assembly 132 and is configured to guide beverage containers downward toward a lower ramp 142. Lower ramp 142 is positioned below upper ramp 140 and assists in directing beverage containers toward a loading element 144. Upper ramp 140 and lower ramp 142 may be angled or contoured to permit beverage containers to advance toward the launch position under the influence of gravity. In some embodiments, upper ramp 140 and lower ramp 142 define a serpentine or zigzag path that organizes beverage containers in rows and feeds the beverage containers sequentially toward loading element 144.

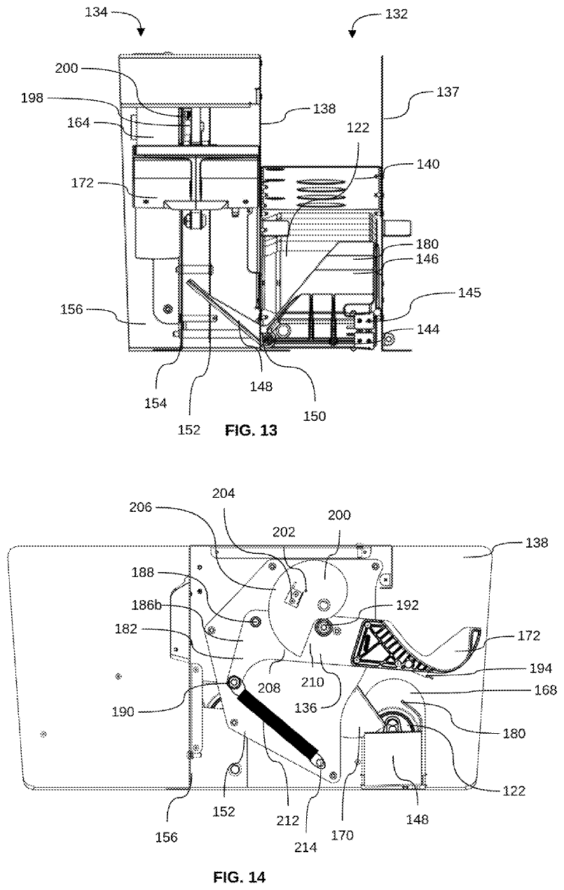

Loading element 144 is disposed within a load opening 168 defined in load assembly rear vertical support 138. Loading element 144 is pivotable about a fulcrum 150 and has a loading element first end 146 and a loading element second end 148. Loading element first end 146 is configured to receive a beverage container from lower ramp 142. Loading element second end 148 is positioned opposite loading element first end 146. Fulcrum 150 is located between loading element first end 146 and loading element second end 148 and provides a pivot point about which loading element 144 rotates to transfer beverage containers from load assembly 132 to launch assembly 134. Loading element 144 may be weighted or biased such that loading element 144 has an initial or natural position in which loading element first end 146 is positioned downward and aligned for receiving a beverage container from lower ramp 142, as shown in FIGS. 13 and 14. For example, loading element first end 146 may include a weighted portion, or a biasing member such as a spring or torsion element may be coupled to loading element 144 to urge loading element first end 146 toward the downward receiving position. Load opening 168 permits loading element 144 to pivot and transfer beverage containers from load assembly 132 into launch assembly 134.

With continued reference to FIGS. 4 and 5, launch assembly 134 includes one or more supports. In the illustrated embodiment, launch assembly 134 includes a launch assembly front vertical support 152, a launch assembly rear vertical support 154, a launch assembly side vertical support 156, and a launch assembly upper horizontal vertical support 158. Launch assembly front vertical support 152 and launch assembly rear vertical support 154 are oriented vertically and provide structural support within launch assembly 134. Launch assembly side vertical support 156 is positioned on a lateral side of launch assembly 134. Launch assembly upper horizontal vertical support 158 is located above launch assembly front vertical support 152 and launch assembly rear vertical support 154, near the top of launch assembly 134. These structural supports define a framework within which launch arm 136 and associated components are mounted. Spacers 160 and fasteners 162 secure the various structural components of load assembly 132 and launch assembly 134 together. Spacers 160 may maintain predetermined distances between structural supports, and fasteners 162 may include screws, bolts, rivets, or other mechanical fastening elements.

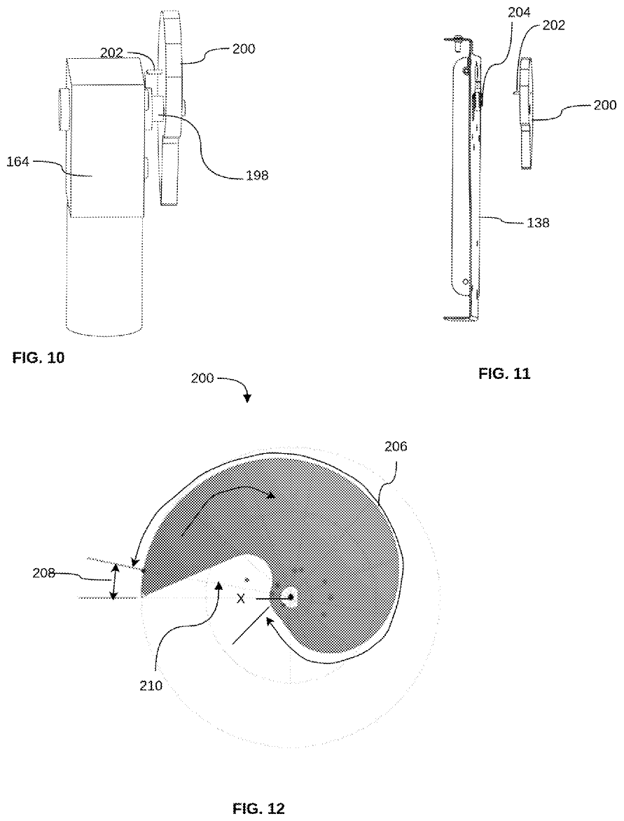

A motor 164 is mounted to launch assembly 134 and drives the launching and loading operations. In the illustrated embodiment, motor 164 is mounted to a rear surface of launch assembly rear vertical support 154 and includes a drive shaft (shown in FIG. 10) that extends through launch assembly rear vertical support 154. Motor 164 may be an electric motor, such as a DC motor or a stepper motor, configured to rotate a cam coupled thereto, as will be described in more detail below. In the illustrated embodiment, controller 166 is mounted on launch assembly upper horizontal vertical support 158 and provides electronic control of the loading and launch sequence. Controller 166 may coordinate operation of motor 164, sensors, and launch activation element 120. Controller 166 may be mounted at various different locations on the assemblies or the body of the insulated container 100. Additionally, the controller may be connected to the motor, sensors, activation element, etc. by wires or by wireless communication.

As described previously, launch assembly 134 includes launch arm 136 that is pivotable about a fulcrum to impart launching force to a beverage container. Launch arm 136 has a beverage container receiving end and a drive end. A cradle 172 is positioned at the beverage container receiving end of launch arm 136 and is configured to receive and hold a beverage container during the launch sequence. The drive end of launch arm 136 is coupled to a biasing member. The arm engages a cam driven by motor 164 between the fulcrum and cradle 172, as described in further detail below.

A beverage container stop door 170 is positioned between load assembly 132 and launch assembly 134. beverage container stop door 170 is configured to control release of beverage containers from load assembly 132 onto cradle 172 at the beverage container receiving end of launch arm 136. Beverage container stop door 170 may be actuated to permit a single beverage container to advance from loading element 144 into cradle 172 while preventing subsequent beverage containers from advancing until the launch sequence is complete. In some embodiments, beverage container stop door 170 may be mechanically linked to and/or may be engaged by launch arm 136 such that movement of launch arm 136 during the loading and launch sequence actuates beverage container stop door 170. In other embodiments, beverage container stop door 170 may be controlled directly by controller 166, which may actuate beverage container stop door 170 via a solenoid, servo motor, or other electromechanical actuator in coordination with the launch sequence. In some embodiments, beverage container stop door 170 is biased toward a closed position by a biasing element such as a spring, torsion bar, or elastic member. The biasing element urges beverage container stop door 170 to remain in the closed position regardless of the orientation of insulated container 100, thereby preventing unintended release of beverage containers during lifting, transport, or tilting of insulated container 100.

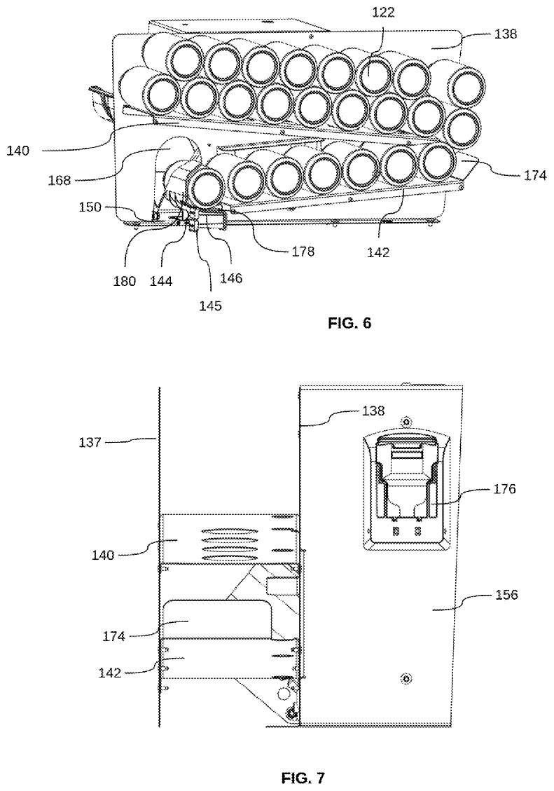

Referring to FIGS. 6 and 7, load assembly 132 and the can storage system are shown in front perspective and side elevation views, respectively. In FIG. 6, load assembly front vertical support 137 is removed to reveal the arrangement of upper ramp 140 and lower ramp 142 within load assembly 132. A plurality of cans 122 are arranged in rows within load assembly 132, held in position by upper ramp 140 and lower ramp 142. In the illustrated embodiment, the upper ramp 140 may include two rows of cans 122 stacked one above the other. While the lower ramp 142 includes a single row of cans 122. Upper ramp 140 and lower ramp 142 cooperate to define a storage configuration within insulated container 100 that organizes and feeds cans 122 toward the launching position. The storage configuration may be selected based on the size and shape of the beverage containers to be stored, the desired capacity of insulated container 100, or the spatial constraints within compartment 123.

With continued reference to FIG. 6, load opening 168 is defined in a lower portion of load assembly 132, through which cans 122 are fed from the storage area toward the launch position. Loading element 144 is positioned adjacent to lower ramp 142, with loading element first end 146 configured to receive a can 122 from lower ramp 142. Fulcrum 150 of loading element 144 is located adjacent to or within load opening 168 and provides a pivot point about which loading element 144 rotates to transfer cans 122 from load assembly 132 through opening 168 to launch assembly 134.

Referring to FIG. 3, optionally, the inner wall of insulated container 100 may provide side boundaries of the area for storing beverage containers. In some embodiments, the inner wall of body 102 cooperates with load assembly 132 to define a storage region within which cans 122 are retained. The inner wall may serve as a lateral boundary that constrains cans 122 as the cans 122 advance along upper ramp 140 and drop to lower ramp 142. This arrangement permits the storage area to utilize the interior volume of insulated container 100 while maintaining orderly positioning of cans 122 during storage and feeding operations. In other alternatives, the storage of beverage containers within the load assembly may be self-contained. For example, the load assembly may include wall or boundaries that surround the stored beverage containers.

Referring to FIG. 7, load assembly front vertical support 137 forms one boundary of load assembly 132. Upper ramp 140 is visible in a central portion of load assembly 132, configured to guide cans 122 downward. Load assembly rear vertical support 138 is positioned centrally and provides structural support. Lower ramp 142 is located below upper ramp 140. Deflector 174 extends upward from lower ramp 142 to direct beverage containers dropping from the upper ramp 140 to the lower ramp 142.

During operation, cans 122 stored on upper ramp 140 advance downward under the influence of gravity toward lower ramp 142. Deflector 174 assists in guiding cans 122 as the cans 122 transition from upper ramp 140 to lower ramp 142. Cans 122 on lower ramp 142 continue to advance toward loading element first end 146. When a can 122 reaches loading element first end 146, loading element 144 receives the can 122 and, when present, beverage container 145 senses the can and sends a signal to the controller to active the motor. The motor is activated to commence the operations that causes loading element 144 to pivot about fulcrum 150 to transfer the can 122 through load opening 168 and into cradle 172 of launch arm 136 in launch assembly 134. This arrangement permits sequential feeding of cans 122 from load assembly 132 to launch assembly 134 for dispensing.

A power supply 176 is mounted in an upper portion of load assembly 132 or launch assembly 134 and provides electrical power for motor 164, controller 166, launch activation element 120, and various sensors within insulated container 100. Power supply 176 may include batteries or rechargeable batteries. In some embodiments, power supply 176 includes a rechargeable battery pack that may be removed from insulated container 100 for recharging. In some alternatives, power supply 176 may include a charging port configured to receive an external power cable for recharging the batteries without removal from insulated container 100. In some alternatives, the power source may include a removable battery pack, a solar charging panel, or a connection port for external power.

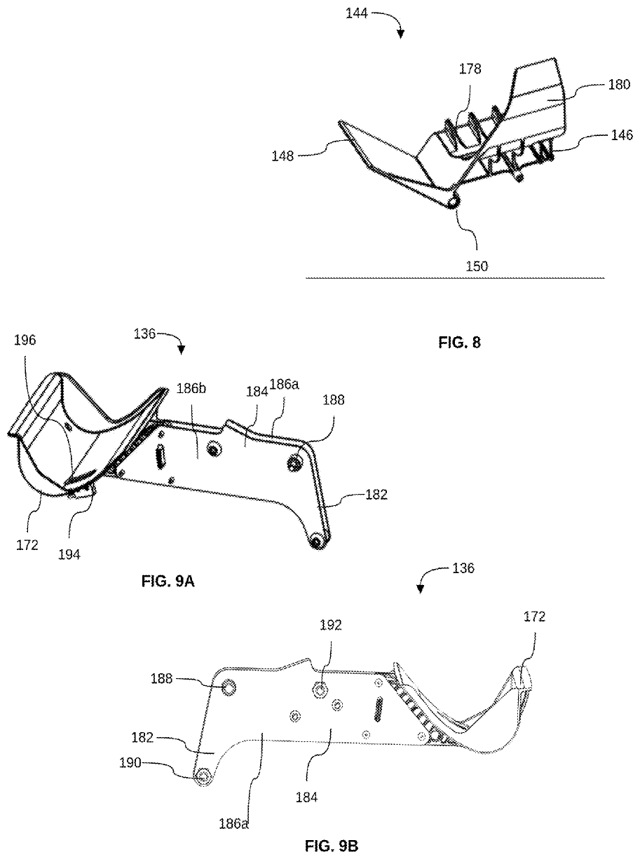

Referring to FIGS. 8, 9A, and 9B, the detailed structure of loading element 144 and launch arm 136 is shown. FIG. 8 illustrates a perspective view of loading element 144. Loading element 144 includes loading element first end 146 and loading element second end 148. Loading element first end 146 includes a seat 178 configured to receive a beverage container, such as can 122. Seat 178 may be contoured or shaped to conform to the outer surface of a beverage container, thereby stabilizing the beverage container during transfer from load assembly 132 to launch assembly 134. Optionally, an upstanding wall 180 extends upward from seat 178 and is configured to retain the beverage container during transfer to the beverage container receiving end of launch arm 136. Upstanding wall 180 may prevent the beverage container from rolling or sliding off of seat 178 as loading element 144 pivots about fulcrum 150.

With continued reference to FIG. 8, loading element second end 148 is positioned opposite loading element first end 146. Fulcrum 150 is located between loading element first end 146 and loading element second end 148 and provides a pivot point about which loading element 144 rotates. In some embodiments, loading element second end 148 may be configured to engage launch arm 136 during the loading sequence. When launch arm 136 moves during the launch sequence, launch arm 136 may contact loading element second end 148, causing loading element 144 to pivot about fulcrum 150. As such, loading element second end 148 serves as lever. This pivoting motion raises loading element first end 146 and transfers the beverage container from seat 178 into cradle 172 of launch arm 136.

When loading element first end 146 is raised during the transfer operation, upstanding wall 180 and the elevated position of loading element 144 may prevent a next can 122 from rolling off the lower ramp. This raised loader configuration maintains separation between the beverage container being transferred and subsequent beverage containers waiting on lower ramp 142, thereby preventing interference during the launching phase of the cycle.

Optionally, a beverage container sensor 145 is associated with loading element 144, as illustrated in FIGS. 4 and 6. Beverage container sensor 145 may be positioned on or adjacent to loading element first end 146. For example, beverage container sensor 145 may be positioned on or adjacent to seat 178 and/or upstanding wall 180. Beverage container sensor 145 is configured to detect a presence of a beverage container in loading element first end 146. In the illustrated embodiment, seat 178 is shaped so that beverage container sensor 145 can detect a beverage container positioned within seat 178. In some embodiments, beverage container sensor 145 may be an optical sensor, a proximity sensor, a mechanical switch, or another type of sensor configured to generate a signal indicating whether a beverage container is present in seat 178. Optionally, in some embodiments controller 166 may inhibit the load sequence if beverage container sensor 145 does not detect a beverage container in seat 178, thereby preventing an empty load cycle.

FIG. 9A illustrates a front perspective view of the launch arm 136. Launch arm 136 includes cradle 172 at one end configured to receive and hold a beverage container during the launch sequence. As described previously, cradle 172 is positioned at the beverage container receiving end of launch arm 136. In some embodiments, cradle 172 is configured to accommodate beverage containers of different diameters and different lengths. For example, cradle 172 may include a stepped or graduated seat having an upper portion configured to receive and support beverage containers of larger diameter and a lower portion configured to receive and support beverage containers of smaller diameter. This configuration permits the apparatus to launch various sizes of beverage containers, such as standard 12-ounce cans, slim cans, or larger 16-ounce cans, without requiring adjustment or replacement of cradle 172. In other alternative, the device may be provided with a set of interchangeable cradles, where the user selected the cradle based on the size of the beverage container. Launch arm 136 further includes an arm 184 extending from cradle 172. Arm 184 may be an elongated structural member that connects cradle 172 to a drive end 182 located at the opposite end of launch arm 136 from cradle 172. In alternative embodiments, the cradle 172 and drive end 182 may be on the same side of the fulcrum. For example, the launch arm may also be a class two or class three lever.

With continued reference to FIG. 9A, in the illustrated embodiment, launch arm 136 includes a first plate 186a and a second plate 186b. First plate 186a and second plate 186b may be spaced apart and oriented parallel to one another. A cam 200 (shown in greater detail in FIG. 14) may be located between first plate 186a and second plate 186b. This arrangement permits cam 200 to engage launch arm 136 between first plate 186a and second plate 186b during the loading and launching operations. As shown in FIG. 13, the cam engages a portion of the launch arm. Optionally, the portion of the launch arm that engages the cam may be or include a cam follower 192. In other embodiments, the arm 184 may be of a single construction. Optionally, launch arm 136 could be a single component of unitary structure, wherein the cradle 172, cam follower 192 and/or arm 184 are a single unit. For example, a single or double shot molded piece or all one metal piece.

A fulcrum 188 is located along arm 184 and provides a pivot point for the launch motion. Fulcrum 188 may be positioned between cradle 172 and drive end 182. When assembled with the launch assembly, fulcrum 188 may be positioned on a rod that extends between launch assembly front vertical support 152 and launch assembly rear vertical support 154. In other embodiments, the rod may be attached to launch assembly front vertical support 152, launch assembly rear vertical support 154, positioned between the supports, or integrated into launch arm 136. Launch arm 136 is configured to rotate about the fulcrum 188 during the loading and launch sequence to propel the beverage container from cradle 172 through aperture 116 of lid 108.

Referring to FIG. 9B, a side elevation view of the rear side of the launch arm 136 is shown. Cradle 172 is visible at one end of launch arm 136, and arm 184 extends horizontally from cradle 172 toward drive end 182 at the opposite end. The outside of the cam follower 192 is visible and the cam follower 192 is located on an upper end of arm 184 fulcrum 188 and cradle 172. Cam follower 192 may be a roller, a pin, or another element positioned between plates 186a and 186b that rides along the profile of cam 200 as cam 200 rotates.

A biasing member attachment location 190 is positioned near drive end 182 at a lower portion of launch arm 136. A biasing member, such as a spring, may be coupled to drive end 182 of launch arm 136 at biasing member attachment location 190. In some embodiments, the biasing member has a first end coupled to launch arm 136 at biasing member attachment location 190 and a second end coupled to a fixed attachment location on launch assembly 134. As will be explained in more detail below, the biasing member stores energy when cam 200 rotates through a variable radius region of the cam profile and releases the stored energy when cam follower 192 traverses a drop-off region of the cam profile, thereby pivoting launch arm 136 about fulcrum 188 to propel the beverage container.

With continued reference to FIG. 9A, a beverage container sensor 194 is positioned adjacent to cradle 172. Beverage container sensor 194 is configured to detect a presence of a beverage container in cradle 172. An opening 196 is defined in cradle 172 so that beverage container sensor 194 can detect a beverage container positioned within cradle 172. In some embodiments, beverage container sensor 194 may be an optical sensor, a proximity sensor, a mechanical switch, or another type of sensor configured to generate a signal indicating whether a beverage container is present in cradle 172. In some embodiments, controller 166 may inhibit the launch sequence if beverage container sensor 194 does not detect a beverage container in cradle 172, thereby preventing an empty launch cycle.

Referring to FIGS. 10, 11, and 12, the motor 164 and cam 200 arrangement is shown in detail. FIG. 10 illustrates a side perspective view of launch assembly 134 with motor 164 and cam 200 exposed. Motor 164 is visible on one side of launch assembly 134, mounted to launch assembly rear vertical support 154 (FIG. 5). A drive axle 198 extends from motor 164 through launch assembly rear vertical support 154 (see FIG. 13). Cam 200 is mounted on drive axle 198 on the opposite side of launch assembly rear vertical support 154 from motor 164. In this configuration, motor 164 is a single motor that drives cam 200 via drive axle 198. Motor 164 may be coupled to cam 200 such that rotation of drive axle 198 causes corresponding rotation of cam 200.

Referring to FIG. 11, a side elevational view of launch assembly 134 shows cam 200 fixed to motor axle 198 such that cam 200 rotates with motor axle 198. A position feature 202 is carried by cam 200 and rotates therewith. In the illustrated embodiment, position feature 202 is a pin, such as a dowel pin or spring pin, configured to actuate a cam position sensor 204 at a predetermined rotational position of cam 200. Cam position sensor 204 is mounted adjacent cam 200 and, in the illustrated embodiment, comprises a limit switch. When position feature 202 actuates cam position sensor 204, cam position sensor 204 generates a signal to controller 166 indicating that cam 200, and thus motor axle 198, has reached a selected rotational position, such as a home position, a loaded position, or a launch position. In some embodiments, position feature 202 may be a discrete component coupled to cam 200. In other embodiments, position feature 202 may be integrally formed with cam 200, such as by molding or machining. In still other embodiments, rotational position may be detected using other sensing arrangements, including a magnetic sensor, an optical sensor, a rotary encoder, motor step counting, or another electronic position sensing system.

Referring to FIG. 12, a plan view of cam 200 shows the cam profile in detail. Cam 200 has a cam profile with regions of varying radius relative to a central cam axis X, which may be the same axis as drive axle 198. As explained in more detail below with respect to FIGS. 13-27, the cam follower 192 of the launch arm 136 rides or follows along the perimeter or profile of the cam to move the launch arm through the various positions of loading and launching.

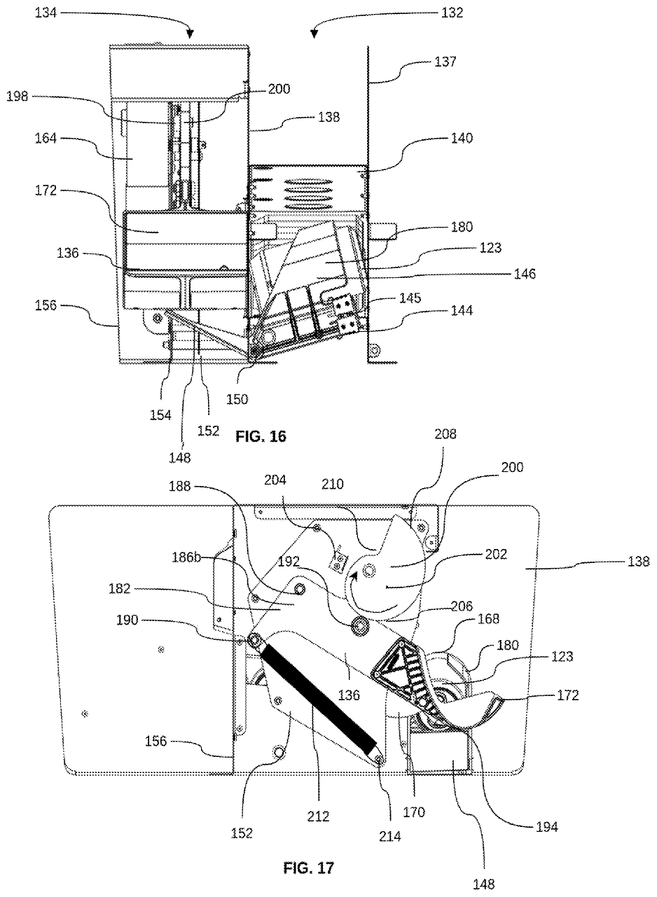

The cam profile includes a loading region of variable radius 206 (variable radius region) that occupies a majority of the cam profile. Loading region of variable radius 206 defines a portion of the outer boundary of cam 200 in which the radial distance from the cam axis varies. In the illustrated embodiment, the radius of the loading region continuously increases in a direction toward dwell or hold region 208. As cam follower 192 traverses loading region of variable radius 206, the varying radius causes controlled displacement of cam follower 192, which in turn pivots launch arm 136 about fulcrum 188. This pivoting motion tensions a biasing member (FIG. 17) coupled to drive end 182 of launch arm 136, thereby storing energy in the biasing member.

With continued reference to FIG. 12, the cam profile further includes a hold or dwell constant radius region 208 (constant radius region) defined along a portion of the outer perimeter of cam 200 between variable radius region 206 and drop-off region 210. Hold or dwell constant radius region 208 is formed as a substantially circular arc having a constant radius relative to the cam axis. As will be explained in more detail below and with reference to FIG. 22, when cam follower 192 engages hold or dwell constant radius region 208, forces transmitted from the biasing member to cam 200 are directed substantially radially toward the cam axis. In this configuration, the biasing member force produces no net torque tending to rotate cam 200. As a result, hold or dwell constant radius region 208 maintains the biasing member in a tensioned state, which may be a stable tensioned state, without continuous motor power. The constant radius region maintains the biasing member in a tensioned state at a first position without continuous motor power.

The cam profile of cam 200 may have a perfectly circular profile at hold or dwell constant radius region 208 such that the spring force is purely radial and does not induce motor rotation. This geometry renders cam 200 non-backdrivable such that motor 164 does not move when not powered, maintaining the loaded state passively. Motor 164 may be de-energized while launch arm 136 remains in the loaded position, thereby conserving battery power and reducing heat buildup. In some embodiments, hold or dwell constant radius region 208 may be substantially circular, such that any deviation from a perfect circle is insufficient to induce rotation of cam 200 under the force applied by the biasing member.

With continued reference to FIG. 12, a launch drop-off or launch region 210 is located at a transition between hold or dwell constant radius region 208 and loading region of variable radius 206. Launch drop-off or launch region 210 defines a reduced radius portion that has a radius less than hold or dwell constant radius region 208. The drop-off region is positioned between the constant radius region and the variable radius region. Launch drop-off or launch region 210 may include a localized reduction in cam radius, an undercut region, or a cam surface discontinuity sufficient to release cam follower 192 from hold or dwell constant radius region 208 and permit rapid arm rotation.

When cam 200 rotates from the loaded position such that cam follower 192 transitions from hold or dwell constant radius region 208 into launch drop-off or launch region 210, the mechanical support previously provided by cam 200 is removed. This transition causes rapid release of stored energy from the biasing member when cam 200 rotates to a second position. As illustrated in FIGS. 24 and 26, the biasing member rapidly contracts and pulls drive end 182 of launch arm 136, thereby pivoting launch arm 136 about fulcrum 188 to propel the beverage container from cradle 172 through aperture 116 of lid 108. The drop-off causes rapid release of stored energy from the biasing member when cam 200 rotates to the second position.

Thus, the biasing member is configured to store energy when cam 200 rotates to a first position corresponding to hold or dwell constant radius region 208 and release energy when cam 200 rotates to a second position corresponding to launch drop-off or launch region 210 to pivot launch arm 136. This cam-based mechanism permits a single motor 164 to perform both loading and launching functions through the geometry of cam 200, reducing mechanical complexity compared to systems that employ multiple motors or separate latching mechanisms.

FIGS. 13 through 26 illustrate the sequence of loading and launching operations of the beverage dispensing apparatus. In these figures, certain components have been removed to show internal features of launch assembly 134 and load assembly 132. For example, in FIGS. 14, 17, 20, 22, 24, and 26, launch assembly rear vertical support 154 and first plate 186a of launch arm 136 have been removed to show details of the interaction between cam 200, launch arm 136, and a biasing member 212.

Referring to FIGS. 13 and 14, load assembly 132 and launch assembly 134 are shown in a ready position prior to a can 122 being loaded into launch assembly 134. In this ready position, cam follower 192 is positioned in launch drop-off or launch region 210 of cam 200. Launch arm 136 is positioned with cradle 172 located above load opening 168 and ready to receive a beverage container, such as can 122.

Biasing member 212 extends from launch arm 136 to a biasing member attachment location 214. Biasing member 212 may be a spring, such as a tension spring or extension spring, having a first end coupled to launch arm 136 at biasing member attachment location 190 near drive end 182 and a second end coupled to biasing member attachment location 214, which is a fixed attachment location on launch assembly 134. In the ready position, biasing member 212 is in a relaxed or minimally tensioned state because cam follower 192 is positioned in launch drop-off or launch region 210 of cam 200.

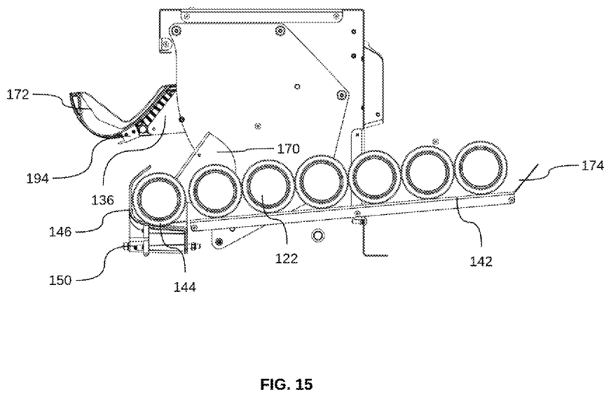

As further shown in FIGS. 14 and 15, the apparatus awaits loading of a can 122 into cradle 172 of launch arm 136. Beverage container stop door 170 is closed preventing release of cans 122 through load opening 168 and into cradle 172. Loading element 144 is positioned with loading element first end 146 aligned receiving a can 122 from lower ramp 142.

Referring to FIGS. 16 and 17, can 122 is positioned on loading element first end 146. The upstanding wall 180 extends upward from loading element first end 146 and retains can 122 during the initial receiving phase. The upstanding wall 180 prevents can 122 from rolling or sliding off of loading element first end 146 as loading element 144 begins to pivot. In this configuration, can 122 is received on the first end of the loading element, as described previously with respect to loading element 144, and triggers beverage container sensor 145, if such a sensor is present. As described above, when sensor 145 is present, controller 166 may inhibit the load sequence if beverage container sensor 145 does not detect a beverage container in seat 178, thereby preventing an empty load cycle.

The controller 166 activates the motor 164 to rotate the cam 200. As the cam 200 rotates, the cam follower 192 moves along the cam profile of the loading region of variable radius 206. The varying radius of the loading region of variable radius 206 causes controlled displacement of the cam follower 192, which in turn drives the launch arm 136 away from a resting position. As the cam follower 192 traverses the loading region of variable radius 206, the launch arm 136 pivots about the fulcrum 188, causing the drive end 182 to move. This pivoting motion tensions the biasing member 212 coupled to the drive end 182 of the launch arm 136, thereby storing energy in the biasing member 212.

As the launch arm 136 pivots during the loading sequence, the cradle 172 at the beverage container receiving end of the launch arm 136 contacts and pushes the loading element second end 148. This contact causes the loading element 144 to pivot about the fulcrum 150. As the loading element 144 pivots, the loading element first end 146 is raised, transferring can 122 from the seat 178 toward the cradle 172 of the launch arm 136. The interaction between the cradle 172 and the loading element second end 148 mechanically links the movement of the launch arm 136 to the pivoting of the loading element 144, permitting the loading operation to occur in coordination with the tensioning of the biasing member 212.

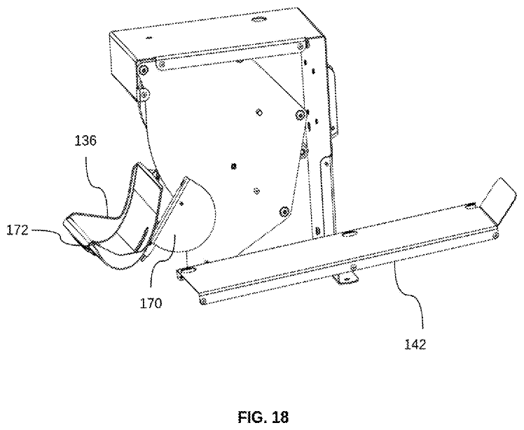

Referring to FIG. 18, a perspective view shows the relationship between the launch arm 136, the beverage container stop door 170, the cradle 172, and the lower ramp 142. In some embodiments, the beverage container stop door 170 may be mechanically linked to the launch arm 136 such that movement of the launch arm 136 during the loading and launching sequence actuates the beverage container stop door 170. In the illustrated embodiment, a portion of the launch arm 136, for example cradle 172, contacts the beverage container stop door 170 to move it to the open position. In other embodiments, the beverage container stop door 170 may be controlled by the controller 166 via a solenoid, servo motor, or other electromechanical actuator. This arrangement permits sequential feeding of cans 122 from the load assembly 132 to the launch assembly 134 while preventing multiple cans 122 from entering the cradle 172 simultaneously.

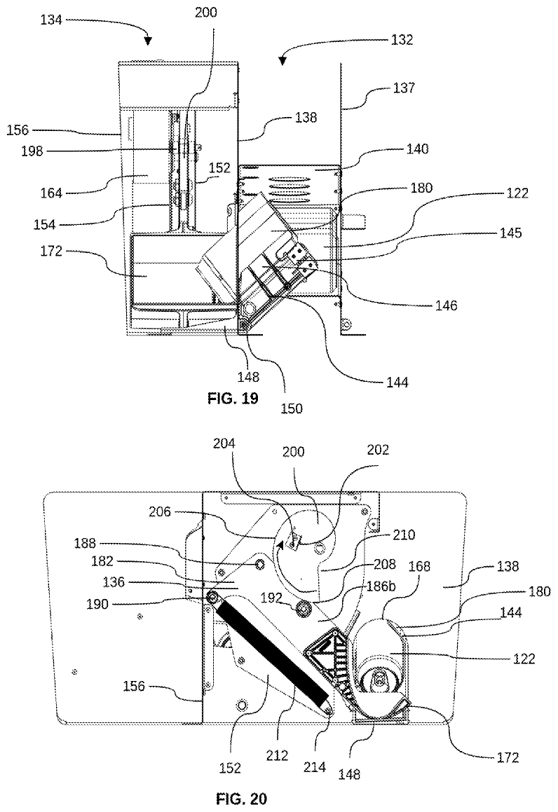

Referring to FIGS. 19 and 20, loading element 144 has pivoted about fulcrum 150 such that loading element first end 146 is raised and can 122 is being transferred toward cradle 172 of launch arm 136. The pivoting motion of loading element 144 about fulcrum 150 transfers can 122 from loading element first end 146 to cradle 172. This lever action raises can 122 from the receiving position on seat 178 to transfer can 122 from loading element first end 146 to cradle 172 of launch arm 136.

Cam follower 192 has traversed a further portion of loading region of variable radius 206 of cam 200. As cam 200 continues to rotate, cam follower 192 moves along the cam profile, causing launch arm 136 to further pivot about fulcrum 188. This pivoting motion of launch arm 136 further tensions biasing member 212. The coordinated movement of launch arm 136 and loading element 144 permits can 122 to be transferred from loading element first end 146 to cradle 172 as biasing member 212 is further tensioned.

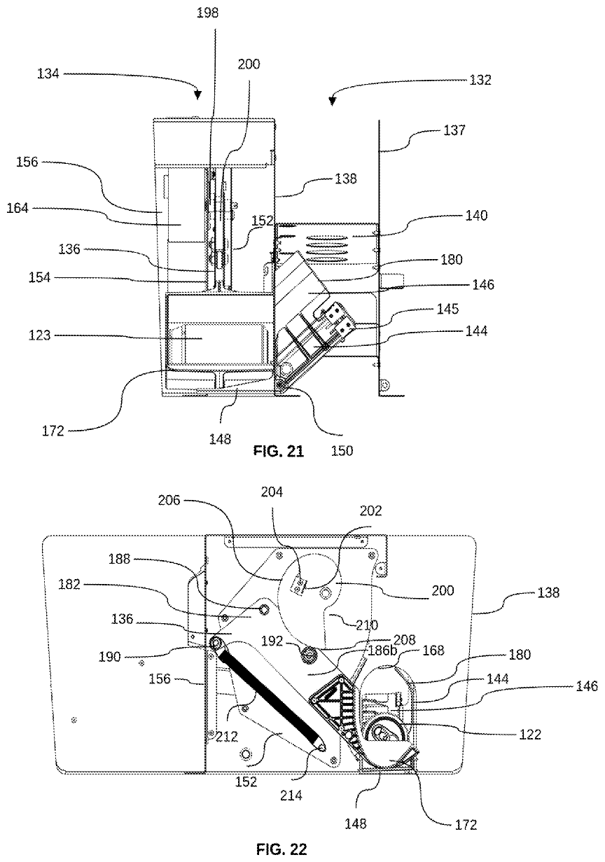

Referring to FIGS. 21 and 22, can 122 is seated within cradle 172 of launch arm 136. The transfer from loading element 144 to cradle 172 is complete and can 122 is positioned for launching. Loading element 144 remains in position with the loading element first end blocking any further movement of the cans on the lower ramp 142.

Cam 200 has been rotated such that cam follower 192 is engaged with hold or dwell constant radius region 208 of the cam profile. In this loaded configuration, cam follower 192 has traversed loading region of variable radius 206 and has entered hold or dwell constant radius region 208. The rotation of cam 200 through loading region of variable radius 206 has tensioned biasing member 212 to store energy.

With continued reference to FIG. 22, position feature 202 extending from cam 200 and comes into contact with cam position sensor 204 when cam 200 reaches the loaded position. When position feature 202 contacts cam position sensor 204, controller 166 receives a signal indicating that cam 200 has reached the loaded position. In response to this signal, controller 166 de-energizes motor 164, stopping rotation of cam 200. The cam 200 and launch arm 136 are held in this loaded state until launch is activated by launch activation element 120. In the loaded configuration, biasing member 212 is in a tensioned state. The tensioned biasing member 212 stores mechanical energy that will be released during the launch sequence to propel can 122 from cradle 172.

Hold or dwell constant radius region 208 includes a uniform radius that defines a true circular arc concentric with cam axis X. When cam follower 192 engages hold or dwell constant radius region 208, the spring force applied through launch arm 136 to cam follower 192 is directed substantially along a radial line intersecting cam axis X. Because the force from biasing member 212 acts substantially radially on cam 200 through cam follower 192, no net torque tending to rotate cam 200 is present. As a result, the mechanism is non-backdrivable, and motor 164 may be de-energized while launch arm 136 remains fully loaded. This configuration permits the apparatus to maintain the loaded state without continuous motor power, thereby conserving battery power and reducing heat buildup in motor 164.

In some embodiments, motor 164 may be non-backdrivable in that motor 164 has sufficient torque resistance so as to not be rotated when de-energized. This motor characteristic may supplement or complement the non-backdrivable geometry of cam 200 to maintain the loaded state. The combination of the cam geometry and the motor torque resistance may provide redundant mechanisms for holding launch arm 136 in the loaded position without continuous power consumption.

The loaded configuration shown in FIGS. 21 and 22 represents a stable holding state in which the apparatus awaits user activation. When a user actuates launch activation element 120, controller 166 energizes motor 164 to rotate cam 200 from the loaded position toward launch drop-off or launch region 210, initiating the launch sequence as described in subsequent figures.

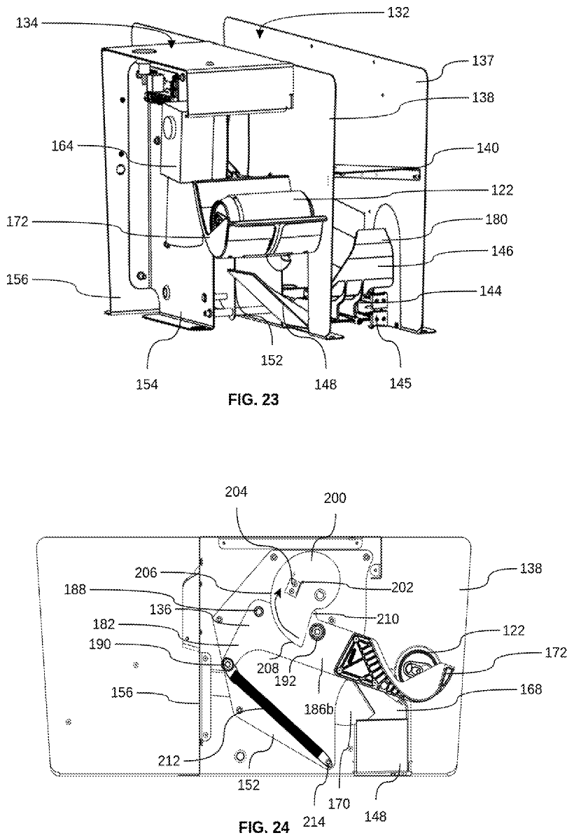

Referring to FIGS. 23 and 24, the launch sequence is initiated when a user actuates launch activation element 120, which signals controller 166 to energize motor 164 and rotate cam 200 so that the cam follower is positioned in the launch drop-off or launch region 210. When cam follower 192 transitions from hold or dwell constant radius region 208 into launch drop-off or launch region 210, the mechanical support previously provided by cam 200 is removed. The reduced radius of launch drop-off or launch region 210 permits cam follower 192 to move rapidly inward toward cam axis X. This transition releases stored energy from biasing member 212, allowing biasing member 212 to pull drive end 182 of launch arm 136 and move cradle 172 upward. As cradle 172 moves upward, the loading element 144 returns to its initial position and the beverage container stop door 170 closes to prevent cans from passing through opening 168. In the illustrated embodiment, the launch arm pivots towards its initial position causing cradle 172 to disengage from loading element second end 148, permitting loading element 144 to pivot back about fulcrum 150 under the influence of gravity or a biasing element. Loading element first end 146 returns to the downward receiving position aligned for receiving a next can 122 from lower ramp 142. Similarly, upward movement of cradle 172 allows beverage container stop door 170 to return to the closed position, preventing release of cans 122 through load opening 168 until the next loading cycle commences.

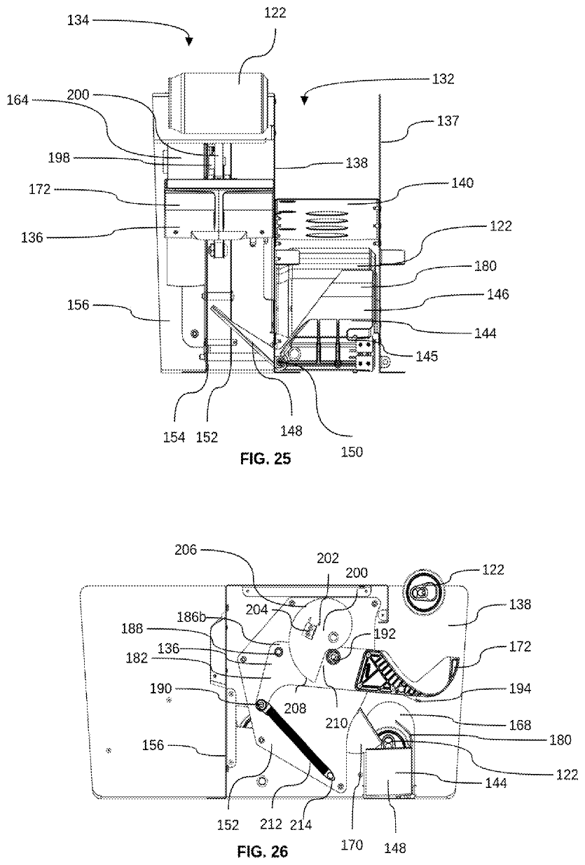

Referring to FIGS. 25 and 26, these figures show the launch itself where cam follower 192 continues to move through the launch drop-off or launch region 210 of cam 200, rapidly pivoting launch arm 136 to propel can 122 upward. In the illustrated embodiment, the continued release of stored energy from biasing member 212 pulls drive end 182 of launch arm 136. This pulling action on drive end 182 pivots launch arm 136 about fulcrum 188, thereby propelling can 122 from cradle 172 through aperture 116 defined in lid 108 of insulated container 100. As shown in FIG. 2, can 122 exits insulated container 100 through aperture 116, with first panel 118a and second panel 118b opening to permit passage of can 122 and returning to a closed position after can 122 passes through aperture 116.

After can 122 is launched, motor 164 continues to rotate cam 200 to commence loading of the next can 122. If a beverage container sensor 145 is associated with loading element first end 146 of loading member 144, the motor will only continue if a new can is loaded into the loading element first end 146 and is sensed by the sensor 145. If a can is not sensed by beverage container sensor 145, the controller will pause the motor and not activate it again until beverage container sensor 145 senses a new can. Optionally, if a can is not sensed by beverage container sensor 145, the insulated container, optionally, may have an indicator indicating the absence of a can to the user. This indicator will let the user know that there is an issue, such as the insulated container is empty or there is an issue with the loading assembly, e.g., cans stuck. The indicator may be a visual or audio indicator, or may be an indicator on a mobile device when one is communicating with the controller.

As cam 200 rotates, cam follower 192 moves from launch drop-off or launch region 210 into loading region of variable radius 206, and the sequence of loading, holding, launch activation, and launching repeats. The rotation of cam 200 through loading region of variable radius 206 tensions biasing member 212 to store energy, as described previously. The loading element 144 receives a next can 122 from lower ramp 142, and the coordinated movement of launch arm 136 and loading element 144 transfers the next can 122 into cradle 172. When cam follower 192 reaches hold or dwell constant radius region 208, controller 166 de-energizes motor 164, and the apparatus awaits user activation of launch activation element 120 to initiate the next launch sequence.

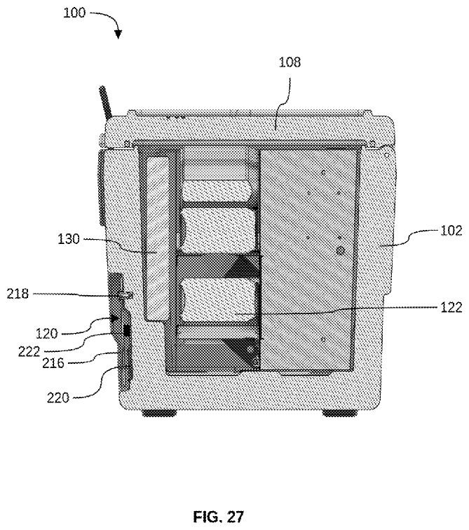

Referring to FIG. 27, launch activation element 120 is mounted on a lower portion of front wall 106 of body 102. Launch activation element 120 is configured for user activation of the launch sequence. Launch activation element 120 includes a kick plate 216 is positioned on front wall 106 of body 102. Kick plate 216 is secured to body 102 by fasteners 218 (also shown in FIGS. 1 and 2). Fasteners 218 may include screws, bolts, rivets, or other mechanical fastening elements configured to attach kick plate 216 to front wall 106 while permitting kick plate 216 to move in response to user actuation.

A kick plate sensor 220 is positioned adjacent to kick plate 216. Kick plate sensor 220 is configured to detect actuation of kick plate 216. In some embodiments, kick plate sensor 220 may be a mechanical switch, a proximity sensor, a pressure sensor, or another type of sensor configured to generate a signal when kick plate 216 is depressed or displaced by a user. When a user presses kick plate 216 with a foot, kick plate sensor 220 detects the actuation and transmits a signal to controller 166 to initiate the launch sequence.

A biasing member 222 is associated with kick plate 216. Biasing member 222 is configured to return kick plate 216 to a rest position after actuation. In some embodiments, biasing member 222 may be a spring, an elastic element, or another resilient component that urges kick plate 216 toward the rest position when the user removes the actuating force. This configuration permits kick plate 216 to function as a repeatable activation mechanism that returns to the rest position after each actuation, ready for subsequent launch activations.

The kick plate arrangement shown in FIG. 27 permits a user to activate the launch sequence by foot actuation while the user's hands remain free to catch the launched beverage container. This hands-free activation may be advantageous in social or outdoor settings where a user may be standing near insulated container 100 and desires to catch a launched can 122 without bending down to actuate a hand-operated switch.

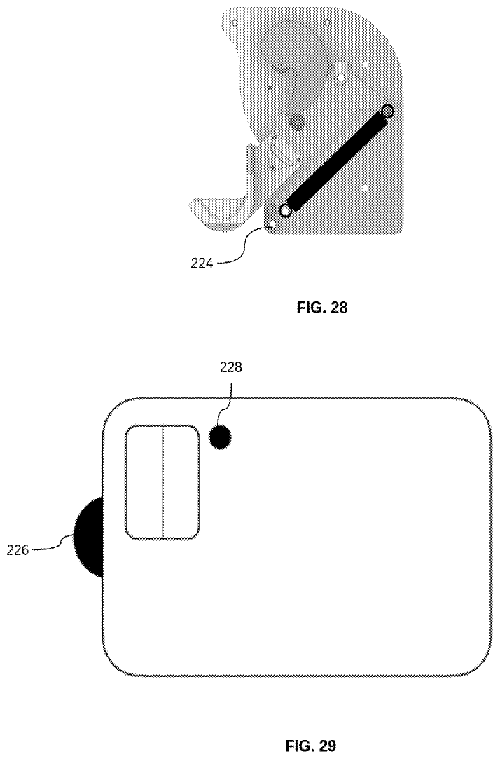

Referring to FIGS. 28 and 29, alternative activation and safety features of the beverage dispensing apparatus are shown. FIG. 28 illustrates a rear plan view of launch assembly 134 with the launch assembly rear vertical support removed, revealing an arm position sensor 224 positioned at a lower portion of the assembly adjacent to the pivot area of launch arm 136. Arm position sensor 224 is configured to detect an angular position of launch arm 136 during the loading and launching sequence. In some embodiments, arm position sensor 224 may be an optical encoder, a rotary potentiometer, a Hall effect sensor, or another type of sensor configured to generate a signal indicating the angular orientation of launch arm 136 relative to a reference position. Controller 166 may receive signals from arm position sensor 224 to monitor the position of launch arm 136 throughout the loading and launching operations. In some embodiments, controller 166 may use the angular position information from arm position sensor 224 to coordinate the timing of motor 164 activation, to verify that launch arm 136 has reached the loaded position, or to confirm that launch arm 136 has completed the launch motion.

Referring to FIG. 29, a top view of insulated container 100 shows the exterior arrangement of activation and safety components. A kick activator 226 is positioned on a side of body 102. Kick activator 226 is configured as a user-operated trigger mechanism for initiating the launch sequence via foot actuation. In some embodiments, kick activator 226 may be positioned on front wall 106, on sidewalls 104, or at a lower portion of body 102 accessible to a user's foot. Kick activator 226 may include a depressible plate, a lever, a pedal, or another foot-operated element that, when actuated, transmits a signal to controller 166 to initiate the launch sequence. This foot-operated configuration permits a user to activate the launch sequence while the user's hands remain free to catch the launched can 122.

In some embodiments, the apparatus may include alternative activation systems in addition to or instead of kick plate 216, kick activator 226, or other mechanical activation elements. In some alternatives, the activation system may include gesture recognition via a camera to detect hand signals for initiating the launch sequence. The camera may be mounted on lid 108, on body 102, or at another location on insulated container 100 with a field of view that includes an area above or adjacent to the apparatus. Controller 166 may process image data from the camera to recognize predefined hand gestures, such as a wave, a thumbs-up, or another gesture, and initiate the launch sequence in response to detection of the predefined gesture.

In some alternatives, the activation system may include an ultrasonic sensor-based detection system to recognize a user's hand movement above the cooler for triggering the launch. The ultrasonic sensor may emit ultrasonic pulses and detect reflections from objects within a detection zone above insulated container 100. Controller 166 may analyze the ultrasonic sensor data to identify hand movements or gestures indicative of a user's intent to initiate the launch sequence. When controller 166 recognizes a predefined hand movement pattern or signal, controller 166 may initiate the launch sequence by energizing motor 164 to rotate cam 200 from the loaded position toward launch drop-off or launch region 210.

With continued reference to FIG. 29, a launch path sensor 228 is positioned near an upper portion of lid 108, adjacent to aperture 116. Launch path sensor 228 is configured to detect obstructions in a launch path above the launch zone to prevent unintended launches. In some embodiments, launch path sensor 228 may include an infrared sensor, a proximity sensor, an ultrasonic sensor, or another type of sensor configured to detect the presence of objects or persons above aperture 116. When launch path sensor 228 detects an obstruction in the launch path, launch path sensor 228 transmits a signal to controller 166. In response to this signal, controller 166 may inhibit the launch sequence to prevent launching of can 122 when an obstruction is present above the launch zone. This safety feature may reduce the risk of accidental contact between a launched can 122 and a person or object positioned above insulated container 100. In some embodiments, controller 166 may provide a visual or audible indication to the user that the launch sequence has been inhibited due to detection of an obstruction, permitting the user to clear the launch path before reattempting activation.

A number of implementations have been described. Nevertheless, it will be understood that various modifications may be made without departing from the spirit and scope of the disclosure. Accordingly, other implementations are within the scope of the following claims.

1. A beverage dispensing apparatus, comprising:
a container configured to store a plurality of beverage containers;
a launch assembly including:
a launch arm pivotable about a fulcrum and having a beverage container receiving end and a drive end;
a cam driven by a single motor and having a cam profile with a variable radius region, a constant radius region, and a drop-off region, wherein the launch arm engages the cam to move the launch arm; and
a biasing member coupled to the drive end of the launch arm; and
wherein rotation of the cam through the variable radius region tensions the biasing member to store energy, and wherein the constant radius region maintains the biasing member in a stable tensioned state without continuous motor power, and wherein further rotation of the cam to the drop-off region of the cam profile releases stored energy from the biasing member to pull the drive end of the launch arm, thereby pivoting the launch arm about the fulcrum to propel a beverage container from the beverage container receiving end of the launch arm.

2. The beverage dispensing apparatus of claim 1, wherein the drop-off region is positioned between the constant radius region and the variable radius region, the drop-off region defining a reduced radius portion that has a radius less than the constant radius region.

3. The beverage dispensing apparatus of claim 2, wherein the drop-off region defines a launch region that causes rapid displacement of the launch arm.

4. The beverage dispensing apparatus of claim 1, wherein the biasing member comprises a spring having a first end coupled to the launch arm and a second end coupled to a fixed attachment location on the launch assembly.

5. The beverage dispensing apparatus of claim 1, further comprising a load assembly configured to feed beverage containers to a beverage container receiving end of the launch arm.

6. The beverage dispensing apparatus of claim 5, wherein the load assembly comprises:
a loading element pivotable about a fulcrum and having a first end configured to receive a beverage container and a second end; and
a ramp configured to guide beverage containers toward the first end of the loading element.

7. The beverage dispensing apparatus of claim 6, wherein the first end of the loading element includes a seat configured to receive the beverage container and an upstanding wall configured to retain the beverage container during transfer to the beverage container receiving end of the launch arm.

8. The beverage dispensing apparatus of claim 5, further comprising a beverage container stop door positioned between the load assembly and the launch assembly, the beverage container stop door configured to control release of beverage containers onto the beverage container receiving end of the launch arm.

9. The beverage dispensing apparatus of claim 1, wherein the container comprises an insulated body and a lid, the lid defining an aperture through which the beverage container is propelled.

10. The beverage dispensing apparatus of claim 9, wherein the aperture is covered by at least one openable panel.

11. The beverage dispensing apparatus of claim 1, further comprising a cam position sensor configured to detect a rotational position of the cam.

12. The beverage dispensing apparatus of claim 1, wherein the constant radius region defines a substantially circular arc concentric with a cam axis such that force from the biasing member acts substantially radially on the cam through a cam follower, producing no net torque tending to rotate the cam, thereby rendering the cam non-backdrivable in the tensioned state.

13. The beverage dispensing apparatus of claim 1, wherein the constant radius region maintains the biasing member in a stable tensioned state without a separate latching mechanism.

14. A method of dispensing a beverage container, comprising:
loading a beverage container into a cradle of a launch arm;
rotating a cam with a single motor to move a portion of the launch arm through a variable radius region of the cam, thereby tensioning a biasing member coupled to the launch arm;
holding the biasing member in a tensioned state by positioning the portion of the launch arm in a constant radius region of the cam without continuous motor power; and
releasing stored energy from the biasing member by rotating the cam to move the portion of the launch arm through a reduced radius region of the cam, thereby pivoting the launch arm to propel the beverage container.

15. The method of claim 14, further comprising detecting a presence of the beverage container in the cradle with a beverage container sensor prior to rotating the cam.

16. A beverage dispensing apparatus, comprising:
an insulated container having a body and a lid with an aperture;
a load assembly configured to store and feed beverage containers toward a launch position;
a launch assembly disposed within the insulated container and including:
a launch arm pivotable to propel a beverage container through the aperture;
a single motor;
a cam coupled to the single motor and engaging the launch arm; and
a biasing member configured to store energy when the cam rotates to a first position and release energy when the cam rotates to a second position to pivot the launch arm.

17. The beverage dispensing apparatus of claim 16, wherein the cam comprises a variable radius region, a constant radius region, and a launch region, wherein the constant radius region maintains the biasing member in a tensioned state at the first position without continuous motor power.

18. The beverage dispensing apparatus of claim 17, wherein the launch region defines a drop-off between the constant radius region and the variable radius region, the drop-off causing rapid release of stored energy from the biasing member when the cam rotates to the second position.

19. The beverage dispensing apparatus of claim 16, wherein the launch arm includes a cam follower engaging the cam and a cradle configured to receive and hold a beverage container during a launch sequence.

20. The beverage dispensing apparatus of claim 18, wherein rotation of the cam from the second position through the variable radius region drives loading of a beverage container from the load assembly onto the launch arm, such that the single motor performs both loading and launching functions through geometry of the cam.
